(19) United States
(12) Patent Application Publication
(10) Pub. No.: US 2012/0235376 A1
(43) Pub. Date: Sep. 20, 2012

(54) Arrangement of a Bracket on a Carrier of a Passenger-Car Body

(75) Inventors: Gerald Huhn, Sindelfingen (DE); Gernot Jäeger, Gaertringen (DE); Guenter Johanntokrax, Simmozheim (DE); Carsten Pech, Sindelfingen (DE); Werner Schwarzl, Lassnitzhoehe (AT); Martin Tebbe, Ammerbuch (DE)

(73) Assignee: Daimler AG, Stuttgart (DE)

(21) Appl. No.: 13/496,098

(22) PCT Filed: Jul. 3, 2010
(86) PCT No.: PCT/EP2010/004045

§ 371 Date: May 30, 2012

(30) Foreign Application Priority Data
Sep. 15, 2009 (DE) 102009041317.0

(51) Int. Cl. B62D 21/09; B62D 25/08

(52) U.S. Cl. 280/124.155

(57) ABSTRACT

An arrangement of a bracket on a structural member of a passenger motor vehicle body is provided. A structural member includes an upper face and a lower face. The structural member can be a longitudinal structural member and the bracket can be a damper strut bracket, via which at least a damper strut can be supported on structural member. The bracket is supported at least on the upper face and on the lower face of structural member.

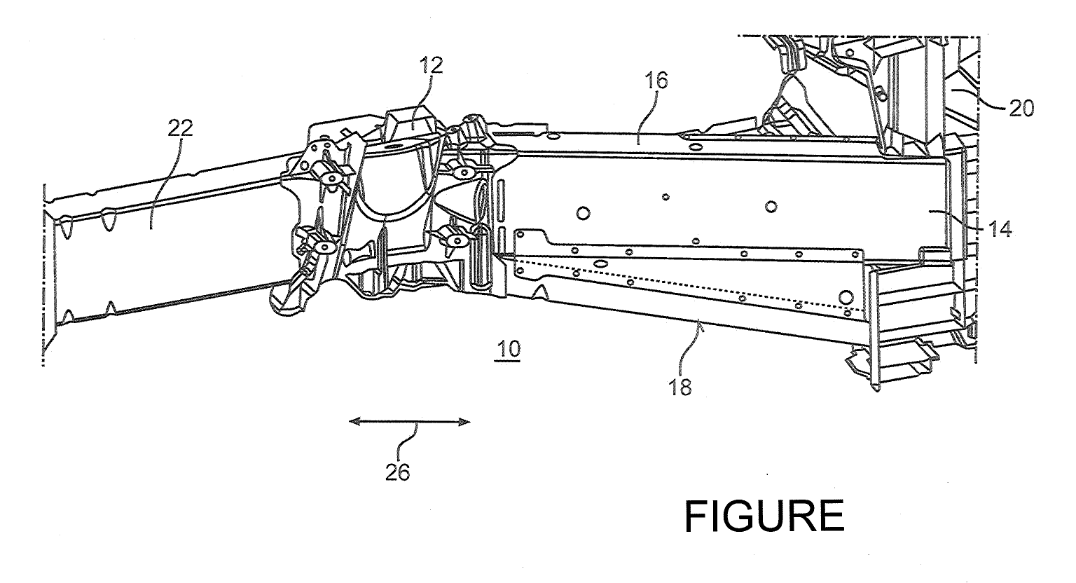

### BACKGROUND AND SUMMARY OF THE INVENTION

The invention relates to an arrangement of a bracket on a structural member on a passenger motor vehicle body.

It is known from series production of motor vehicles to design the longitudinal structural member in several sections in order to support suspension components, for example, a damper strut assigned to a wheel, and to provide it with stiffening means and local strengthening means, in order to achieve stable and secure support of the damper strut.

This requires increased manufacturing effort in order to achieve such a longitudinal structural member, which means that the costs for the longitudinal structural member and for the entire body are undesirably increased. Additionally, this results in more difficult tolerance compensation, in particular in the case of a longitudinal structural member in several sections, which also gives rise to high costs.

The aforementioned stiffening means or local strengthening means of the longitudinal structural member are generally connected with the longitudinal structural member by a welding process, which results in distortion of the component due to the high heat transmission. This makes tolerance compensation still more difficult, or even impossible.

In addition, a homogenous load path is not made possible, which is associated with unfavorable transmission of forces and therefore higher stresses.

In addition, in order to connect the damper strut to the longitudinal structural member, multi-part damper strut brackets are known, whose support on the longitudinal structural member is only realised inadequately, which gives rise again to the need for extensive strengthening measures. This has the same disadvantages already described in connection with the stiffening means and/or local strengthening means.

Exemplary embodiments of the present invention provide an arrangement of a bracket on a structural member of a passenger motor vehicle body that improves the flow of forces.

Exemplary embodiments of the present invention improve the flow of force using an arrangement of a bracket on a structural member of a passenger motor vehicle body.

An arrangement of a bracket on a structural member of a passenger motor vehicle body according to the invention comprises a structural member having an upper face and a lower face, in particular a longitudinal structural member, and a bracket, in particular a damper strut-bracket, by means of which at least one suspension component of the motor vehicle, in particular a damper strut, can be supported on the structural member. In this arrangement, the bracket is supported on the upper face and on the lower face of the structural member, which leads to an improved flow of forces and improved transmission of forces via the bracket into the structural member.

Damper forces resulting from a wheel moving up and down by spring force can therefore be transmitted via the damper strut and the bracket into the structural member both via its upper face and also via its lower face, which avoids locally very high and therefore stressful loading of the structural member. The forces are therefore dissipated on two sides and the structural member is more evenly loaded, which reduces the probability of failure of the arrangement according to the invention in comparison with the state of the art.

It is advantageous if the bracket is basically C-shaped and formed in one piece and if it encircles the structural member, which is for example designed in the form of a longitudinal structural member, by means of this C-profile, whereby the transmission of forces is improved and the number of components of the arrangement according to the invention can be kept within narrow limits. This low number of components leads to low cost for the arrangement according to the invention, which has a positive effect on the overall costs for the entire passenger motor vehicle body.

The arrangement according to the invention also allows time-, work- and cost-intensive additional measures, such as for example stiffening means an/or local strengthening means, to become obsolete, which keeps both the weight and the costs low. The fact that additional strengthening means or similar are no longer needed also avoids the welding process described above and the resulting component distortion. The arrangement according to the invention can be manufactured in an extremely precise fashion and with only very low tolerances. The fact that the welding process is no longer necessary also leads to a further cost reduction, as less time and less material, such as for example weld fillers, electrodes and similar are needed.

In one advantageous embodiment of the invention, a continuous and one-part structural member, in particular a longitudinal structural member, is provided, which exhibits two longitudinal areas which are at a 180° different angle in the main direction of extension of the structural member. In connection with the advantageously one-piece and C-shaped bracket, which is also supported on the upper face and on the lower face of the structural member, an arrangement is created which fulfils all requirements with regard to low installation space requirements and favourable transmission of forces, in particular from a front end of the passenger motor vehicle body connected with the longitudinal structural member on the one hand, through the longitudinal structural member to a vehicle pillar connected with it, for example an A pillar, on the other hand.

The aforementioned extremely small installation space requirement of the arrangement according to the invention avoids package problems, as they particularly occur in an area of the suspension where space is critical. Design adaptations and changes resulting in expenditure of time and cost are also thereby avoided.

For the purposes of further cost saving, the bracket is designed in the form of a cast part, which means that the bracket can be manufactured rapidly, at low cost and in very large volumes.

An extremely low-cost but nevertheless very efficient tolerance compensation is created by the fact that in an advantageous embodiment of the invention, the bracket, prior to fixed connection with the structural member, is held on the structural member in moveable fashion along the structural member, in particular in the longitudinal axis of the vehicle (x-axis). When tolerances have been compensated for by the movement of the bracket, the bracket can be permanently connected with the structural member, whereby a fixed advantageous support, for example of a damper strut, is realised through the bracket on the longitudinal member.

A further advantage associated with the support of the bracket on the upper and the lower face of structural members is that by means of this two-stage force distribution, a two-stage deformation characteristic curve is shown, which enables better accident behaviour of the passenger motor vehicle body, in particular in the area of the arrangement.

Further advantages, features and details of the invention result from the following description of a preferred embodiment and also from reference to the drawing. The features and combination of features mentioned in the above description and also the features shown alone and the combination of features shown in the description of the Figure and/or in the Figure itself, are not only capable of use in the combination stated, but also in other combinations or alone, without stepping beyond the boundaries of the invention.

### BRIEF DESCRIPTION OF THE FIGURE

In the FIGURE, the drawing shows a section of a perspective view of an arrangement of a bracket on a longitudinal structural member of a passenger motor vehicle body, whereby the bracket is supported on an upper face and a lower face of the longitudinal structural member.

### DETAILED DESCRIPTION

The FIGURE shows an arrangement 10 in which a bracket 12 is supported on a longitudinal structural member 14 of a passenger motor vehicle body. Bracket 12 serves to support a suspension component (not shown in the FIGURE), such as a suspension strut, on the longitudinal structural member 14, which for its part is supported on the one hand on an A-pillar 20 of the passenger motor vehicle body. Accordingly, arrangement 10 can be used in a front area of a passenger motor vehicle. On the other hand, the longitudinal structural member 14 is connected with a front end 22 of the passenger motor vehicle body.

In order to achieve a favourable flow of forces and favourable transmission of damper forces via bracket 12 into longitudinal structural member 14, bracket 12 is basically C-shaped, which means that it basically exhibits a C-shaped longitudinal sectional profile (the direction of the section corresponds to the longitudinal extension direction of longitudinal structural member 14.

Bracket 12 now encircles longitudinal structural member 14 by means of this C-shaped longitudinal section profile and is supported on both its upper face 16 and its lower face 18. The damper strut forces can therefore be transmitted into longitudinal structural member 14 via both upper face 16 and lower face 18. In this, longitudinal structural member 14 is continuous and formed as one piece. This means that a continuous force path is created from front end 22 of the passenger motor vehicle to A pillar 20 or to a front wall.

As bracket 12 is designed as a one-piece cast part and therefore has low manufacturing costs, arrangement 10 altogether exhibits an extremely small number of parts and therefore an extremely low weight, which helps to reduce fuel consumption and therefore CO₂ emissions of the passenger motor vehicle.

Through the advantageous form of the force transmission and the load path, as can be seen from the FIGURE, additional strengthening measures, such as, for example, strengthening plates or similar, are not necessary, which means that the weight of arrangement 10 can be kept low and high heat transmission by means of a welding process for connection of the strengthening means with longitudinal structural member 14 can be avoided. Distortion of components therefore does not occur.

Simple tolerance compensation is achieved in that bracket 12 is held in moveable fashion on longitudinal structural member 14 in the longitudinal axis of the motor vehicle (x axis) in accordance with a directional arrow 26 before fixed connection with longitudinal structure member 14. This also means that complex tolerance compensation processes or tolerance compensation means are not required, and leads to lower costs and lower weight of arrangement 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-8. (canceled)

9. An arrangement, comprising:
a bracket; and
a structural member of a passenger motor vehicle body, wherein the bracket is configured on the structural member and the structural member includes an upper face (16) and a lower face, via which at least one suspension component of the motor vehicle can be supported on structural member, and wherein the bracket is supported at least on the upper face and on the lower face of the structural member.

10. The arrangement of claim 9, wherein the structural member is a longitudinal structural member, the bracket is a damper strut-bracket, and the at least one suspension component of the motor vehicle is a damper strut.

11. The arrangement according to claim 10, wherein the bracket encircles at least some areas of the structural member.

12. The arrangement according to claim 10, wherein the bracket is basically C-shaped.

13. The arrangement according to claim 10, wherein the bracket is formed in one piece.

14. The arrangement according to claim 10, wherein the bracket is held moveably along the structural member before fixed connection with the structural member.

15. The arrangement according to claim 10, wherein the structural member is formed in one piece.

16. The arrangement according to claim 10, wherein the structural member includes at least two longitudinal areas that enclose an angle that is different from 180 degrees.

17. The arrangement according to claim 10, wherein the bracket is a cast part.
